(19) United States
(12) Patent Application Publication
(10) Pub. No.: US 2025/0099887 A1
(43) Pub. Date: Mar. 27, 2025

(54) FILTER MATERIAL COMPRISING A GRADIENT STRUCTURE NONWOVEN BASE LAYER AND A NANOFIBER TOP LAYER

(71) Applicant: FIBERTEX NONWOVENS A/S, Aalborg Ost (DK)

(72) Inventors: Cesarino Mario JEPPESEN, Aalborg (DK); Kari Tapio LUUKKONEN, Turku (FI); Anders FONSS, Gistrup (DK)

(73) Assignee: FIBERTEX NONWOVENS A/S, Aalborg Ost (DK)

(21) Appl. No.: 18/564,105

(22) PCT Filed: Nov. 6, 2023
(86) PCT No.: PCT/EP2023/080867

§ 371 Date: Nov. 27, 2023

(30) Foreign Application Priority Data
Feb. 6, 2023 (EP) 23155011.2

(51) Int. Cl. B01D 39/16; B01D 46/52

(52) U.S. Cl. CPC B01D 39/163; B01D 46/521; B01D 2239/0225; B01D 2239/025; B01D 2239/0631; B01D 2239/0659; B01D 2239/0663; B01D 2239/10; B01D 2239/1233; B01D 2239/1291

(57) ABSTRACT

The invention relates to a filter material comprising a gradient structure nonwoven base layer and a nanofiber top layer, wherein the base layer, forming the media inlet side of the filter material in use, functions as a pre-filtration and dust holding layer.

The invention relates to a pleatable filter material for use in particle filters of cars or heating, ventilation or air conditioning systems.

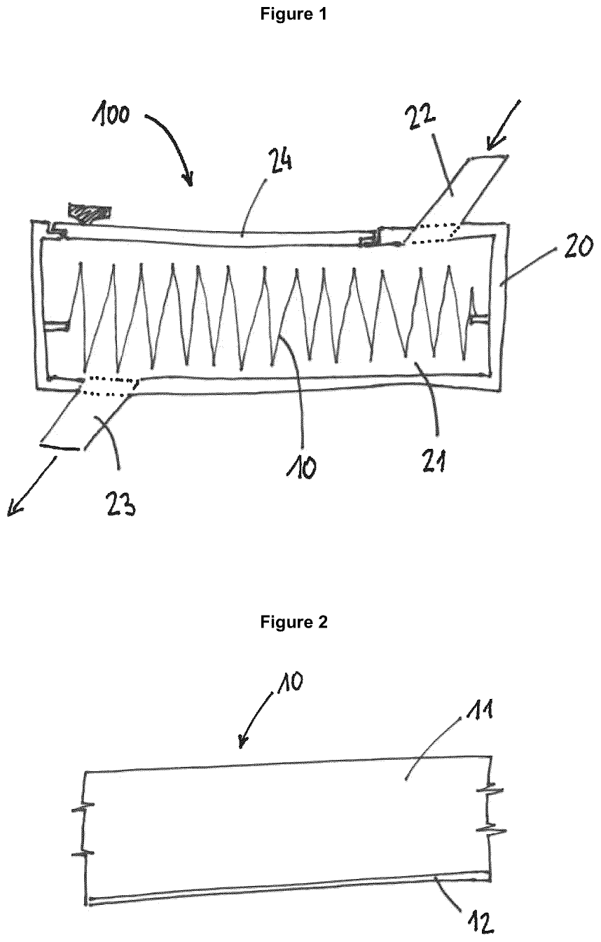

Pleatable filter materials of the generic kind are known. They are typically provided as flat sheets, pleated in a pleating machine and inserted into a filter housing. FIG. 1 shows a typical configuration of a filter 100 provided with such filter material 10. The filter 100 comprises a filter housing 20 with a filtration chamber 21 and an air inlet 22 and an air outlet 23 on opposite sides of the filtration chamber 21. The pleated filter material 10 is positioned in the filtration chamber 21 such as to form a barrier between the air inlet 22 and the air outlet 23. The chamber 21 is covered by a cap 24, which can reversibly be opened and closed for changing the filter material 10 during maintenance. The pleated structure of the filter material 10 increases the filter surface area that is available for the air to pass and be filtered. The number of pleats also influences the air permeability of a filter, in that a more open configuration with less pleats increases air permeability.

Different nonwoven structures have been proposed as pleatable filter materials for the purposes described above. For example, WO 2011/106537 A2 proposes using thin nonwoven filter materials comprising a layer of nanofibers disposed on the media outlet surface. The nanofibers can be obtained by electrospinning and have fiber diameters of less than 100 nm. Such materials are very effective in removing also very small dust particles from a media stream and have high filtration efficiency even at low filter surface areas. However, they tend to have a low dust holding capacity, to clog easily and require frequent maintenance because all particles tend to deposit in one plane of the filtration material immediately before the nanofiber layer. Hence, materials having no nanofiber layer remain industry standard, despite a lower filtration efficiency.

The invention aims to provide a filter material of the generic kind, which allows for a construction of filters with less surface area while maintaining high filtration efficiency, and which has a high dust holding capacity and long lifetime.

Against this background, the invention proposes a pleatable filter material for use in particle filters, the filter material comprising: a nonwoven base layer having a media inlet surface and a media outlet surface; and a nanofiber top layer disposed on the media outlet surface of the base layer.

According to the invention, the nonwoven base layer is a gradient material whose cross-section comprises at least two sub-layers of different fiber structure in terms of different fibers, different fiber packing, or both. The invention hence proposes to a filter material comprising a gradient structure nonwoven base layer and a nanofiber top layer. The base layer, forming the media inlet side of the filter material in use, functions as a pre-filtration and dust holding layer. Due to its gradient structure, is able to hold back dust particles at different planes of the filter and reduces the amount of dust particles held in a plane immediately before the outlet side nanofiber top layer. The filter materials have a high filtration efficiency, a high dust holding capacity and long lifetime. The high filtration efficiency allows to reduce the surface area and increase the air permeability of filters while maintaining equal filtration quality, which ultimately allows for savings in energy consumption of cars or air conditioning systems, in which filter materials of the invention are used.

The nonwoven base layer is an integral material, wherein fibers of each sub-layer extend into an adjacent sub-layer, leading to a gradual change in fiber structure at the interface between the at least two sub-layers of different fiber structure. This stands in contrast to a laminated base material comprising two distinct layers of sharp boundary. Such integral base layer material with a gradient structure can be produced by laying two fibrous webs having a different fiber composition on top of another, e.g. by carding of staple fibers or spinning of endless fibers onto a conveyor belt, and then bonding the layered webs together by, e.g. spunlacing or needling to form one integral base layer.

The fiber structure, according to the invention, differs at least in that the average linear mass density of the fibers in the sub-layer adjacent the media inlet surface of the nonwoven base layer is higher than the average linear mass density of the fibers in the sub-layer adjacent the media outlet surface of the nonwoven base layer. In other words, the linear mass density of the fibers, as expressed in denier or dtex, which is a measure of fiber fineness and increases with decreasing fiber fineness, decreases towards the outlet surface of the base layer. This means, in other words, that fibers get finer (meaning thinner) towards the outlet surface of the base layer The finer average fibers closer to the outlet surface lead to an, on average, denser structure of the base layer close to the media outlet surface. The denser structure is able to hold back finer dust particles, after larger dust particles are already absorbed at the more open sub-layer close to the media inlet surface.

In one embodiment, the nonwoven base layer is a carded material. Carded materials are staple fiber materials, where the staple fibers are laid onto a conveyor to form fibrous webs, that are then bonded to obtain nonwoven structures. As an alternative to carded materials, the base layer may also be formed, at least in part, from endless fibers obtained by, e.g. meltblowing or spunbonding.

In one embodiment, the nonwoven base layer is bonded by spunlacing. During spunlacing, also known as hydroentangling, fibers of the different sub-layers hence become hydroentangled together and many fibers from one sub-layer extend into the other sub-layer. As an alternative to spunlacing, the method may also use needling, for example.

In each of the sub-layer adjacent the media inlet surface, the sub-layer adjacent the media outlet surface, or both, the fibers may be mixtures of at least two fractions of fibers of different linear mass density. For example, in each sub-layer, a fraction of large denier fibers (where a large denier can be different in each sub-layer) can be homogenously mixed with a fraction of fibers of smaller denier. In each sub-layer, or at least the inlet-side sub-layer, the fraction of the large denier fibers preferably accounts for more than 20%, preferably for more than 30% by weight of the overall fibers of the sub-layer. The fractions of smaller denier fibers can have improved mobility during bonding the integral base layer together, and can serve purposes like an of adjusting overall air permeability of the filter material. In one example, in the sub-layer adjacent the media inlet surface, the fraction with the largest linear mass density comprises fibers of between 5-20 dtex, preferably 6-15 dtex. In the sub-layer adjacent the media outlet surface, the fraction with the largest linear mass density may comprise fibers of 2-5 dtex.

In one embodiment, the fibers forming for the sub-layer adjacent the media inlet surface, the sub-layer adjacent the media outlet surface, or both, may be fibers made of thermoplastic polymers, and preferably comprise polyester fibers, polyethyleneterephtalate (PET) fibers, polybutyleneterephtalate (PBT) fibers, polylactide (PLA) fibers or polyolefin fibers. Preferred polyolefin fibers are polypropylene (PP) or polyethylene (PE) fibers. The melting temperature of the thermoplastic polymer material is preferably 150° C. or higher, as determined with DSC according to ISO 11357-3.

In one embodiment, the filter material of any preceding claim, wherein the fibers forming for the sub-layer adjacent the media inlet surface, the sub-layer adjacent the media outlet surface, or both, comprise bicomponent fibers. Bicomponent fibers comprise at least two different components distributed symmetrically (e.g. sheath-core) or asymmetrically (e.g. side-by-side, eccentric sheath-core) over their diameter. In particular, for one of the components of the bicomponent fiber, which is exposed to the fiber surface, e.g. as a sheath component, a thermoplastic polymer of a melting temperature lower than the melting temperature of the other component of the bicomponent fiber, e.g. lower than 200° C. (DSC, DIN EN ISO 11357-3) can be used. This promotes bonding together of the fibers after thermal treatment in production, e.g. by air through bonding. The bonded structure in the product forms the basis for its pleatability.

In a specific embodiment, the fibers forming for the sub-layer adjacent the media outlet surface may comprise bicomponent fibers, and the second component exposed to the fiber surface may be a thermoplastic polymer of a lower melting temperature. The fibers forming for the sub-layer adjacent the media outlet surface are usually thinner (lower denier). Thinner fibers create more bonding points because there are more of them compared to thicker fibres with similar mass. Without being bound by theory, the hypothesis is that the more fibers you have, the more bonding points you get and thus a better integrity.

The nanofibers forming for the nanofiber top layer may have an average fiber diameter of smaller than 250 nm, preferably of between 50 and 150 nm. The nanofibers are preferably polymer fibers, wherein the polymer is selected from the group consisting of polyvinylidene difluoride (PVDF), Polytetrafluoroethylene (PTFE), polyamide, polyether sulfone, PLA, polyacrylonitrile (PAN), polycarbonate or polyurethane. Nanofibers as described can be obtained by electrospinning and deposited directly onto the media outlet surface of the base layer.

The filter material of the invention in one embodiment has an area weight of between 50 and 200 g/m², preferably between 75 and 125 g/m². The material thickness (caliper) as determined according to WSP120.6, can lie between 0.5 and 1.5 mm. The relative basis weights of the sub-layers adjacent the media inlet and outlet surfaces of the base layer, respectively, preferably are between 30/70 and 70/30.

A key aspect of the filter materials of the invention is an improved dust holding capacity. In embodiments, the dust holding capacity at 300 Pa as measured according to EN16890 (at 5.33 cm/s) can be greater 50 g/m², preferably greater 60 g/m² or even greater 70 g/m². The dust holding capacity at 100 Pa (EN16890 at 5.33 cm/s) can be greater 20 g/m², preferably greater 30 g/m² or even greater 40 g/m². Dust holding capacity determines filter life.

The (initial) pressure drop of the filter material, in one embodiment, can be between 8 and 15 Pa, as measured according to ISO16890 (5.33 cm/s). Pressure drop is ultimately equivalent to energy usage of the filter. If the pressure drop stays relatively low, e.g. smaller 100 Pa for longer times (see dust holding capacity above), this is beneficial for saving energy over the life of the filter.

The filtration efficiency of the base layer can reach between 10% and 20%, as measured with 0.3 micron NaCl particle at 5.33 cm/sec, TSI model 8130A. The air permeability of the filter material, in one embodiment, can be adjusted to be between 2000 and 3000 I/(m²·s), as measured according to EN9237 (200 Pa).

The invention further relates to a method for making a pleatable filter material as described above, the method comprising: providing a nonwoven base layer having a media inlet surface and a media outlet surface; and depositing a nanofiber top layer on the media outlet surface of the base layer.

According to the invention, the nonwoven base layer is provided by laying at least two fibrous webs having a different fiber composition in terms of different fibers, different fiber packing, or both on top of another and then bonding the layered webs together in a way as to make fibers of each sub-layer extend into an adjacent sub-layer.

The two fibrous webs can be formed by carding. For example, a first set of fibers in a first card for one sub-layer can be laid onto a conveyor, and a second set of fibers forming for the other sub-layer can be laid on top. The method can use wet-laying or dry-laying. Dry-laying can be preferred. Alternative options for the formation of the fibrous webs comprise meltblowing or spunbonding.

The bonding of the layered webs can include spunlacing. Alternative options comprise needling. The spunlace materials can be dried in an oven.

Additional bonding of fibers and the nonwoven material, specifically activation of possible lower melting point components in bicomponent fibers can be done by air-through bonding.

The nanofiber layer can be formed by electrospinning of nanofibers directly onto the base layer. Preferably, the electrospinning is carried out after drying and air-through bonding. Also off-line settings where the nanofiber layer is deposited on pre-fabricated base layers can be used in one embodiment.

After deposition of the nanofiber layer, the finished pleatable nonwoven filter material may be rolled up on a material roll for transport.

The invention also relates to the use of a pleatable filter material as described in particle filters, particularly air particle filters. The filter media is preferably used for depth filtration. Applications include filters for heating, ventilation and air conditioning (HVAC), protective face masks and respirator media, cabin air filtration media, engine air intake filtration media for vehicles, appliances filter media, or HEPA (High Efficient Particulate Air) filter media.

Further details and advantages of the invention are described in the following with reference to working example and figures. The figures show:

FIG. 1: a filter comprising a pleated filter material as a filtration medium;

FIG. 2: a cross-section through a pleatable filter material of the invention;

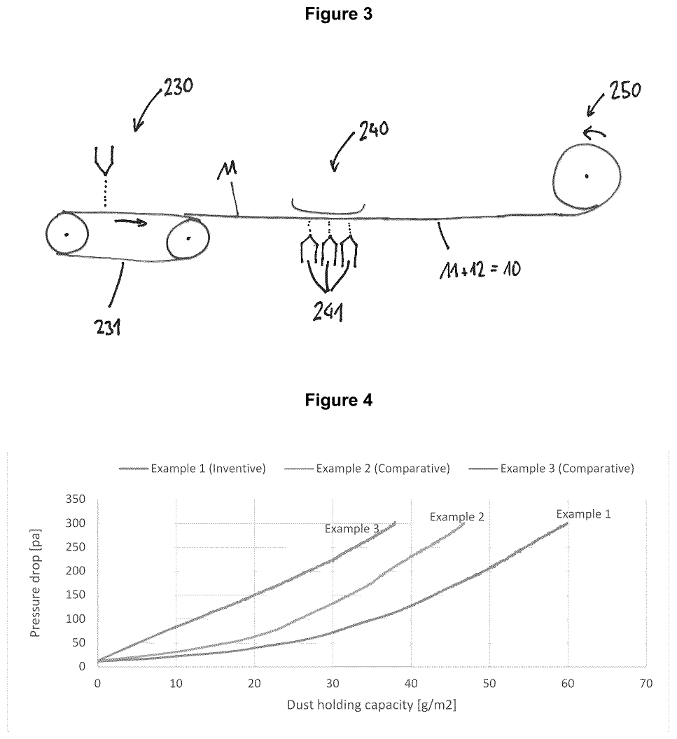

FIG. 3: an exemplary line setup for making a filter material of the invention and; and

FIG. 4: curves for pressure drop versus dust loading for inventive and comparative filter media.

FIG. 2 shows a pleatable filter material 10 according to the invention. The material comprises a nonwoven base layer 11 and a nanofiber top layer 12 on an outlet surface thereof.

The nonwoven base layer 11 is a gradient material whose cross-section comprises at least two sub-layers of different fiber structure. The filter material 10 is intended to be pleated and then inserted into the filtration chamber of an air filter, for example an air filter 100 as described in FIG. 1, such that the nanofiber layer is on the side of the filter material facing the outlet 23 of the filter chamber 21. This way the air stream, when flowing through the filter 100, first flows through the nonwoven base layer 11, where larger dust particles are successively removed in depth filtration. Only a fraction, mainly the smallest particles, are hence deposited in a plane adjacent the nanofiber top layer 12. Therefore, as compared to prior art products comprising nanofiber layers, filter life is increased.

FIG. 3 shows a first embodiment of a line setup for making a filter material 10 of the invention. The line 200 comprises a station 230 for forming the nonwoven base layer 11 and an electrospinning station 240 for depositing the nanofiber top layer 12 on the air outlet side surface nonwoven base layer 11, thereby forming the filter material 10, which is then rolled up on a rolling station 250. The station 230 for forming the nonwoven base layer 11 comprises a carding machine with two cards and a conveyor belt 231. The electrospinning station 240 comprises number of electrospinning cells 241 configured to generate the fine fibers from PVDF. The fine fibers are deposited on the air outlet side surface nonwoven base layer 11. The finished pleatable nonwoven filter material 10 is then rolled up at rolling station 250 to form rolls, which can be stored and transported to a customer.

### Example 1 (Inventive)

An inventive air filter material by the structure as broadly illustrated in FIG. 2 was prepared in a process as broadly illustrated in FIG. 3.

The base material was prepared by carding, where two different layers of fibrous webs were stacked (dry) on top of each other. The fiber mixture for each card are composed of at least two different fibres. In the card of the air inlet sub-layer, a 1-15 dtex PET staple fibers mix with an average linear mass density of around 4 dtex was contained. In the card for the air outlet sub-layer, a 2-6 dtex bicomponent staple fibers mix was contained, with an average linear mass density of around 3 dtex. The bicomponent fibers had a PET core and a sheath with a lower melting point (˜180° C.) thermoplastic polymer. The basis weight of the air inlet sub-layer fibrous web was 40 g/m². The basis weight of the air outlet sub-layer fibrous web was 60 g/m². The sub-layers were spunlaced together, dried in a first oven and air-through bonded in a second oven to form a base layer. On the air outlet surface of that base layer, a PVDF nanofiber layer having fibers of 50-150 nm average fiber diameter were deposited by electrospinning.

### Example 2 (Comparative)

A comparable air filter material where the base material was prepared by carding one uniform layer of fibrous web. The fiber mixture is composed of two different staple fibres, where one of the fibres are a bicomponent fiber. The 2-6 dtex bicomponent fibers had a PET core and a sheath with a lower melting point (˜180° C.) thermoplastic polymer. The other 1-15 dtex PET fiber was solid. The basis weight of the web was 100 g/m². The layer was spunlaced together and dried in an oven. On the air outlet surface of that base layer, a PVDF nanofiber layer having fibers of 50-150 nm average fiber diameter were deposited by electrospinning.

### Example 3 (Comparative)

A comparable air filter material made of glass fibres, which is the standard filter media used in HVAC.

FIG. 4 shows the curves for pressure drop versus dust loading for the filter medium according to inventive example 1 and the comparative filter medium of comparative example 2.

The below Table 1 lists selected properties measured for Example 1, Comparative Example 2 and Comparative Example 3.

TABLE 1

| Characteristic | Method | Unit | Ex. 1 | Comp. Ex. 2 | Comp. Ex. 3 |
|---|---|---|---|---|---|
| Material weight | EN ISO 9864 | g/m² | 100 | 100 | 65 |
| Thickness | EN ISO 9073-2 | mm | 0.58 | 0.59 | 0.50 |
| @ 0.5 kPa | | | | | |
| Air permeability | EN 9237 | I/(m²s) | 900 | 879 | 1100 |
| @ 200 Pa | | | | | |
| Initial pressure drop | EN16890 | Pa | 11 | 12 | 8 |
| @ 5.33 cm/s | | | | | |
| Dust holding capacity | EN16890 | g/m² | 60 | 47 | 38 |
| @ 300 Pa | | | | | |
| Filter class | EN16890 | % | 65 | 65 | 50 |
| ePM1 @ 5.33 cm/s | | | | | |

As apparent from the curves of FIG. 4, the filter according to the invention has a significantly improved dust holding capacity and much slower increase in the pressure drop over the filter than in the comparative material. This leads to a longer filter life and translates into a lower energy consumption when using the filter. This is especially beneficial for energy saving in HVAC or automotive applications. The energy rating is determined according to Eurovent 4/21—2019 ISO ePM₁ by adding 200 grams of dust to the filter. If the filter media, in its pleated form, is between 13-18 m² it results in a dust application between 11.1 and 15.4 g/m². The average pressure drops from zero to 11.1 g/m² and from zero to 15.4 g/m² are listed in Table 2. From the average pressure drop a comparable energy consumption is calculated since the average pressure drop is directly proportional to the energy consumption. As apparent from the curves of FIG. 4, the filter according to this invention has an energy consumption of 33% compared to a standard glass filter media and 71% compared to a homogeneous synthetic media with similar efficiency. Alternative, the size of the inventive filter can be reduced while maintaining equal filtration efficiency, average pressure drop and energy consumption compared to the comparable examples.

TABLE 2

| | Ex. | Comp. | Comp. | Ex. | Comp. | Comp. |
|---|---|---|---|---|---|---|
| | 1 | Ex. 2 | Ex. 3 | 1 | Ex. 2 | Ex. 3 |
| Filter size | 18 m² | | | 13 m² | | |
| Average | 16.3 | 22.1 | 48.8 | 19.2 | 27.1 | 66.8 |
| pressure | | | | | | |
| drop (Δ̅p̅) | | | | | | |
| Energy | 33% | 45% | 100% | 71% | 100% | 246% |
| consumption | | | | | | |
| (W/W) | | | | | | |

1. A pleatable filter material for use in particle filters, the filter material comprising:
a nonwoven base layer having a media inlet surface and a media outlet surface; and
a nanofiber top layer disposed on the media outlet surface of the base layer; wherein
the nonwoven base layer is a gradient material whose cross-section comprises at least two sub-layers of different fiber structure in terms of different fibers, different fiber packing, or both;
wherein fibers of each sub-layer extend into an adjacent sub-layer, such that the nonwoven base layer is an integral material with a gradual change in fiber structure at the interface between the at least two sub-layers of different fiber structure; and
wherein the average linear mass density of the fibers in the sub-layer adjacent the media inlet surface of the nonwoven base layer is higher than the average linear mass density of the fibers in the sub-layer adjacent the media outlet surface of the nonwoven base layer.

2. The filter material of claim 1, wherein the nonwoven base layer is a carded material.

3. The filter material of claim 1, wherein the nonwoven base layer is bonded by spunlacing.

4. The filter material of claim 1, wherein the nonwoven base layer is bonded by needling.

5. The filter material of claim 1, wherein the sub-layer adjacent the media inlet surface, the sub-layer adjacent the media outlet surface, or both, are formed from mixtures of at least two fractions of fibers of different linear mass density.

6. The filter material of claim 1, wherein the fibers forming for the sub-layer adjacent the media inlet surface, the sub-layer adjacent the media outlet surface, or both, are fibers made of thermoplastic polymers.

7. The filter material of claim 1, wherein the fibers forming for the sub-layer adjacent the media outlet surface comprise bicomponent fibers, and wherein one of the components of the bicomponent fiber, which is exposed to the fiber surface, is a thermoplastic polymer having a melting temperature that is lower than the melting temperature of the other component of the bicomponent fiber as determined by DSC according to DIN EN ISO 11357-3.

8. The filter material of claim 1, wherein the nanofibers forming for the nanofiber top layer have an average fiber diameter of smaller than 250 nm.

9. The filter material of claim 1, wherein the nanofibers forming for the nanofiber top layer are electrospun nanofibers.

10. The filter material of claim 1, wherein the nanofibers are polymer fibers, wherein the polymer is selected from the group consisting of polyvinylidene difluoride (PVDF), Polytetrafluoroethylene (PTFE), polyamide, polyether sulfone, PLA, polyacrylonitrile (PAN), polycarbonate or polyurethane.

11. A method for making a pleatable filter material according to claim 1, the method comprising:
providing a nonwoven base layer having a media inlet surface and a media outlet surface; and
depositing a nanofiber top layer on the media outlet surface of the base layer; wherein
the nonwoven base layer is provided by laying at least two fibrous webs having a different fiber composition in terms of different fibers, different fiber packing, or both on top of another and then bonding the layered webs together in a way as to make fibers of each sub-layer extend into an adjacent sub-layer.

12. The method of claim 11, wherein the fibrous webs are formed by carding.

13. The method of claim 10, wherein the bonding of the layered webs includes spunlacing or needling.

14. The method of claim 11, wherein the nanofiber layer is formed by electrospinning of nanofibers directly onto the base layer.

15. A particle filter comprising the pleatable filter material according to claim 1.

16. The filter material of claim 1, wherein the fibers forming for the sub-layer adjacent the media inlet surface, the sub-layer adjacent the media outlet surface, or both, are fibers comprising polyester fibers, PET fibers, PBT fibers, polylactide fibers or polyolefin fibers.

17. The filter material of claim 1, wherein the fibers forming for the sub-layer adjacent the media outlet surface comprise bicomponent fibers, and wherein one of the components of the bicomponent fiber, which is exposed to the fiber surface, is a thermoplastic polymer having a melting temperature that is below 200° C., as determined by DSC according to DIN EN ISO 11357-3.

18. The filter material of claim 1, wherein the nanofibers forming for the nanofiber top layer have an average fiber diameter of between 50 and 150 nm.
